(19) United States
(12) Patent Application Publication
(10) Pub. No.: US 2007/0192824 A1
(43) Pub. Date: Aug. 16, 2007

(54) Computer hosting multiple secure execution environments

(75) Inventors: Alexander Frank, Bellevue, WA (US); William J. Westerinen, Sammamish, WA (US); Thomas G. Phillips, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/353,470

(22) Filed: Feb. 14, 2006

(51) Int. Cl. H04L 9/00

(52) U.S. Cl. 726/1

(57) ABSTRACT

A plurality of secure execution environments may be used to bind individual components and a computer to that computer or to blind computers to a given system. The secure execution environment may be operable to evaluate characteristics of the computer, such as memory usage, clock validity, and pay-per-use or subscription purchased data, to determine compliance to an operating policy. Each of the secure execution environments may exchange information regarding its own evaluation of compliance to the operating policy. When one or more secure execution environments determines noncompliance or when communication between secure execution environments cannot be established a sanction may be imposed, limiting functionality or disabling the computer.

### BACKGROUND

Pay-as-you-go or pay-per-use business models have been used in many areas of commerce, from cellular telephones to commercial laundromats. In developing a pay-as-you go business, a provider, for example, a cellular telephone provider, offers the use of hardware (a cellular telephone) at a lower-than-market cost in exchange for a commitment to remain a subscriber to their network. In this specific example, the customer receives a cellular phone for little or no money in exchange for signing a contract to become a subscriber for a given period of time. Over the course of the contract, the service provider recovers the cost of the hardware by charging the consumer for using the cellular phone.

The pay-as-you-go business model is predicated on the concept that the hardware provided has little or no value, or use, if disconnected from the service provider. To illustrate, should the subscriber mentioned above cease to pay his or her bill, the service provider deactivates their account, and while the cellular telephone may power up, calls cannot be made because the service provider will not allow them. The deactivated phone has no “salvage” value, because the phone will not work elsewhere and the component parts do not have a significant street value. When the account is brought current, the service provider will re-allow use of the device to make calls.

This model works well when the service provider, or other entity taking the financial risk of providing subsidized hardware, has a tight control on the use of the hardware and when the device has little salvage value. The business model does not work well when the hardware has substantial uses outside the service provider's span of control. Thus, a typical computer does not meet these criteria since a computer may have substantial uses beyond an original intent and the components of a computer, e.g. a display or disk drive, may have a significant salvage value.

### SUMMARY

operating policy for a computer or a computer resource, particularly a pay-per-use or subscription computer or component, may define the rules for compliance with established business terms associated with the resource's acquisition, how to measure compliance to the rules, and what to do when the measurements indicate non-compliance. To monitor and enforce the operating policy, a secure execution environment may be employed. The secure execution environment may be a separate component or may be embedded within one of the other components of the computer. Because a single secure execution environment, particularly a standalone secure execution environment, may draw the attention of hackers and other fraud-minded users, more than one secure execution environment may be employed in the computer. Communication between the secure execution environments may help to ensure both that no single secure execution environment has been hacked, replaced or otherwise subverted, and also that the components hosting the various secure execution environments are present and operational. Several exemplary configurations of multiple secure execution environments are discussed below. Each secure execution environment may operate independently and impose a sanction after determining the computer is under attack or being used outside the operating policy. Another embodiment may allow collecting a vote of all the secure execution environments before imposing sanctions under the same circumstances. More weight and veto rights may be used to give preference to certain secure execution environments believed to have inherently higher security.

A secure execution environment may be distinguished from a trusted computing base (TCB) or next generation secure computing base (NGSCB) in that the secure execution environment does not attempt to limit the features or functions of the computer, nor does it attempt to protect the computer from viruses, malware, or other undesirable side effects that may occur in use. The secure execution environment does attempt to protect the interests of an underwriter or resource owner to ensure that pay-per-use or subscription terms are met and to discourage theft or pilfering of the computer as a whole or in part.

### BRIEF DESCRIPTION OF THE DRAWINGS

FIG. 1 is a functional block diagram of a computer;

FIG. 2 is an architectural block diagram of the computer of FIG. 1;

FIG. 3 is a block diagram of a secure execution environment;

FIG. 4 is an architectural block diagram of an alternate embodiment of the computer of FIG. 2; and

FIG. 5 is a network of computers with linked secure execution environments.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Many prior-art high-value computers, personal digital assistants, organizers and the like are not suitable for use in a pre-pay or pay-for-use business model as is. As discussed above, such equipment may have significant value apart from those requiring a service provider. For example, a personal computer may be disassembled and sold as components, creating a potentially significant loss to the underwriter of subsidized equipment. In the case where an Internet service provider underwrites the cost of the personal computer with the expectation of future fees, this “residual value” creates an opportunity for fraudulent subscriptions and theft. Pre-pay business models, where a user pays in advance for use of a subsidized, high value computing system environment have similar risks of fraud and theft.

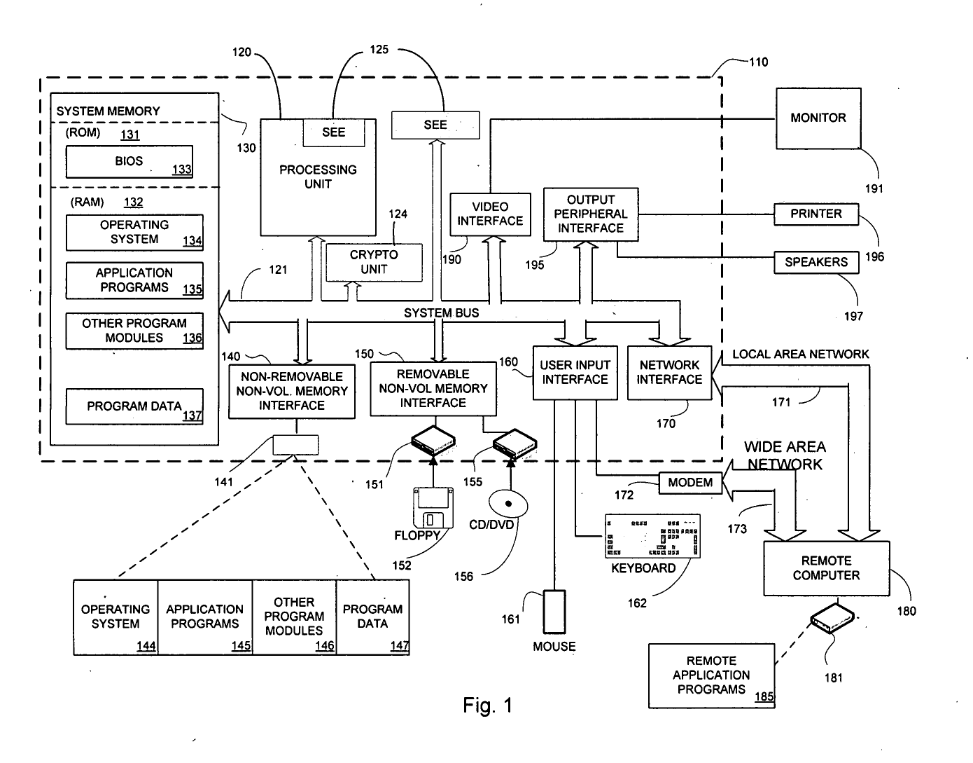

FIG. 1 illustrates a computing device in the form of a computer 110 that may be connected to a network, such as local area network 171 or wide area network 173 and used to host one or more instances of a secure execution environment. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 124 providing cryptographic services. Such services may include support for both symmetric and asymmetric cryptographic algorithms, key generation, random number generation and secure storage. Cryptographic services may be provided by a commonly available integrated circuit, for example, a smart chip such as those provided by Atmel Corporation, Infineon Technologies, or ST Microelectronics.

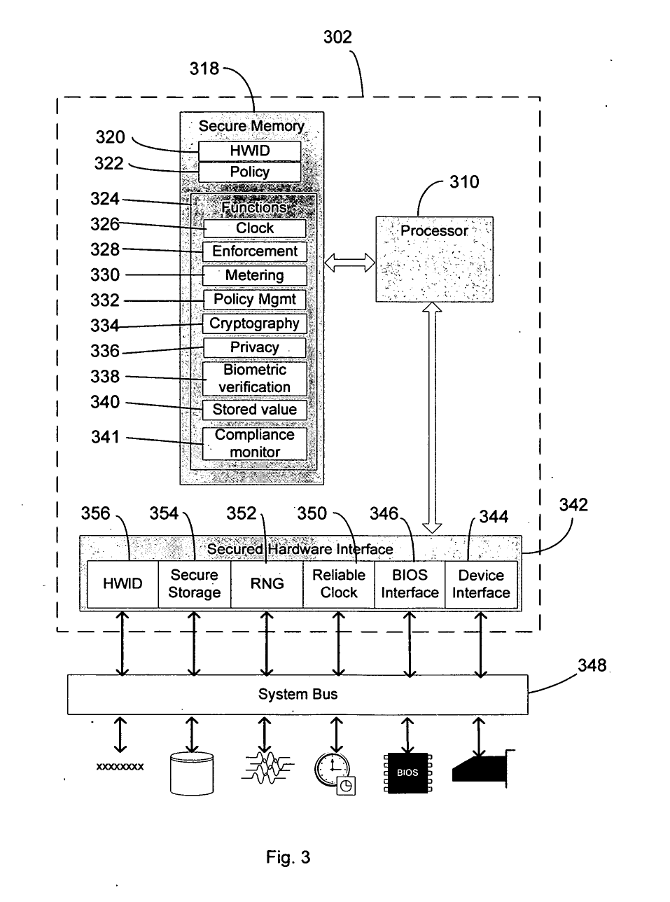

The computer 110 may include a secure execution environment 125 (SEE). The SEE 125 may be enabled to perform security monitoring, pay-per-use and subscription usage management and policy enforcement for terms and conditions associated with paid use, particularly in a subsidized purchase business model. The secure execution environment 125 may be embodied in the processing unit 120 or as a standalone component as depicted in FIG. 1. The detailed functions that may be supported by the SEE 125 and additional embodiments of the SEE 125 are discussed below with respect to FIG. 3.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146,.and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

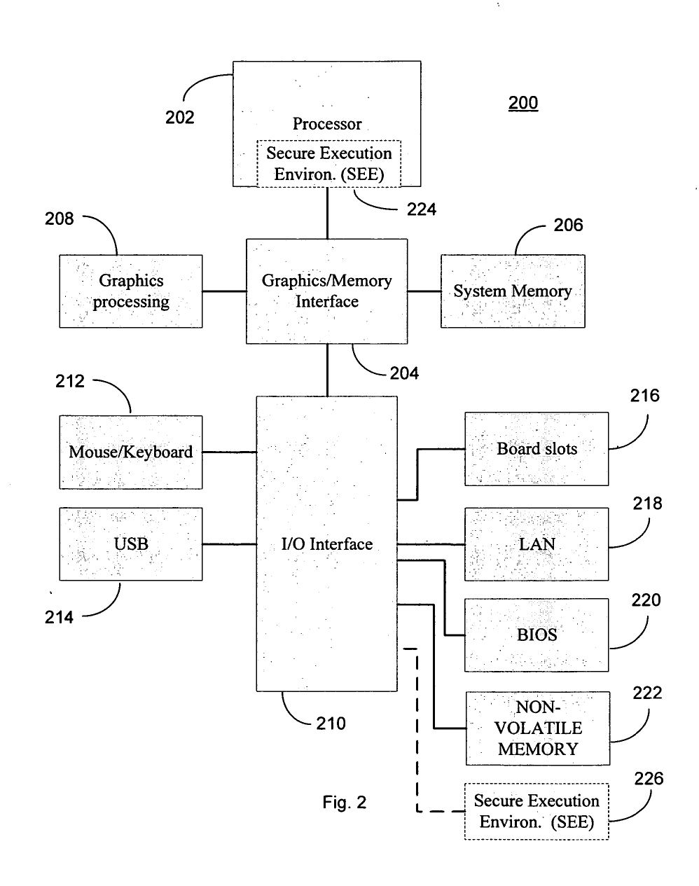

FIG. 2 is an architectural block diagram of a computer 200 the same as or similar to the computer of FIG. 1. The architecture of the computer 200 of FIG. 2 may be typical of general-purpose computers widely sold and in current use. A processor 202 may be coupled to a graphics and memory interface 204. The graphics and memory interface 204 may be a “Northbridge” controller or its functional replacement in newer architectures, such as a “Graphics and AGP Memory Controller Hub” (GMCH). The graphics and memory interface 204 may be coupled to the processor 202 via a high speed data bus, such as the “Front Side Bus” (FSB), known in computer architectures. The graphics and memory interface 204 may be coupled to system memory 206 and a graphics processor 208, which may itself be connected to a display (not depicted). The processor 202 may also be connected, either directly or through the graphics and memory interface 204, to an input/output interface 210 (I/O interface). The I/O interface 210 may be coupled to a variety of devices represented by, but not limited to, the components discussed below. The I/O interface 210 may be a “Southbridge” chip or a functionally similar circuit, such as an “I/O Controller Hub” (ICH). Several vendors produce current-art Northbridge and Southbridge circuits and their functional equivalents, including Intel Corporation.

A variety of functional circuits may be coupled to either the graphics and memory interface 204 or the I/O Interface 210. The graphics and memory interface 204 may be coupled to system memory 206 and a graphics processor 208, which may itself be connected to a display (not depicted). A mouse/keyboard 212 may be coupled to the I/O interface 210. A universal serial bus (USB) 214 may be used to interface external peripherals including flash memory, cameras, network adapters, etc. (not depicted). Board slots 216 may accommodate any number of plug-in devices, known and common in the industry. A local area network interface (LAN) 218, such as an Ethernet board may be connected to the I/O interface 210. Firmware, such as a basic input output system (BIOS) 220 may be accessed via the I/O interface 210. Nonvolatile memory 222, such as a hard disk drive, may also be coupled to the I/O interface 210.

A secure execution environment 224 may be embedded in the processor 202. Alternatively, or supplemental to the secure execution environment 224 may be a second secure execution environment 226 coupled to the computer via the I/O interface 210. A generic secure execution environment, the same as or similar to SEEs 224 226 is discussed in more detail below with respect to FIG. 3.

FIG. 3 is a block diagram of an exemplary secure execution environment 302, such as may be found in computer 200 of FIG. 2. The secure execution environment 302 may include a processor 310, a secure memory 318 and an interface 342.

The secure memory 318 may store, in a tamper-resistant manner, code and data related to the secure operation of the computer 302, such as a hardware identifier 320 and policy information 322. The policy information 322 may include data related to the specific terms and conditions associated with the operation of the computer 200. The secure memory 318 may also include code or data required to implement various functions 324. The functions 324 may include a clock 326 or timer implementing clock functions, enforcement functions 328, metering 330, policy management 332, cryptography 334, privacy 336, biometric verification 338, stored value 340, and compliance monitoring 341, to name a few.

The clock 326 may provide a reliable basis for time measurement and may be used as a check against a system clock maintained by the operating system 134 to help prevent attempts to fraudulently use the computer 200 by altering the system clock. The clock 326 may also be used in conjunction with policy management 332, for example, to require communication with a host server to verify upgrade availability. The enforcement functions 328 may be executed when it is determined that the computer 200 is not in compliance with one or more elements of the policy 322. Such actions may include restricting system memory 132 by reallocating generally available system memory 206 for use by the secure execution environment 302 and thus preventing its use by the processor 202. By reallocating system memory 206 to the secure execution environment 302, the system memory 206 is essentially made unavailable for user purposes.

Another function 324 may be metering 330. Metering 330 may include a variety of techniques and measurements, for example, those discussed in co-pending U.S. patent application Ser. No. 11/006,837. Whether to meter and what specific items to measure may be a function of the policy 322. The selection of an appropriate policy and the management of updates to the policy may be implemented by the policy management function 332.

A cryptography function 334 may be used for digital signature verification, digital signing, random number generation, and encryption/decryption. Any or all of these cryptographic capabilities may be used to verify updates to the secure memory 318 or to established trust with an entity outside the secure execution environment 302 whether inside or outside of the computer 200.

The secure execution environment 302 may allow several special-purpose functions to be developed and used. A privacy manager 336 may be used to manage personal information for a user or interested party. For example, the privacy manager 336 may be used to implement a “wallet” function for holding address and credit card data for use in online purchasing. A biometric verification function 338 may be used with an external biometric sensor (not depicted) to verify personal identity. Such identity verification may be used, for example, to update personal information in the privacy manager 336 or when applying a digital signature. The cryptography function 334 may be used to establish trust and a secure channel to the external biometric sensor.

A stored value function 340 may also be implemented for use in paying for time on a pay-per-use computer or while making external purchases, for example, online stock trading transactions.

The use of data and functions from the secure memory 318 allows presentation of the secured hardware interface 342 for access by other systems in the computer 200. The secured hardware interface 342 may allow restricted and or monitored access to peripheral devices 344 or the BIOS 346 via the system bus 348. Additionally, the functions 324 may be used to allow external programs, including the operating system 134, to access secure facilities such as hardware ID 356 and random number generation 352 of the cryptographic function 334 via the secured hardware interface 342. Other capabilities accessible via the system bus 348 may include secure storage 354 and a reliable (monotonically increasing) clock 350.

Each function 324 discussed above, as implemented in code and stored in the secure memory 318 may be implemented in logic and instantiated as a physical circuit. The operations to map functional behavior between hardware and software are well known in the art and are not discussed here in more detail.

In one embodiment, the computer 200 may boot using a normal BIOS startup procedure. At a point when the operating system 134 is being activated, the processor 310 may execute the policy management function 332. The policy management function 332 may determine that the current policy 322 is valid and then load the policy data 322. The policy may be used in a configuration process to set up the computer 200 for operation. The configuration process may include allocation of memory, processing capacity, peripheral availability and usage as well as metering requirements. When metering is to be enforced, policies relating to metering, such as what measurements to take may be activated. For example, measurement by CPU usage (pay-per-use) versus usage over a period of time (subscription), may require different measurements. Additionally, when usage is charged per period or by activity, a stored value balance may be maintained using the stored value function 340. When the computer 300 has been configured according to the policy 322, the normal boot process may continue by activating and instantiating the operating system 134 and other application programs 135. In other embodiments, the policy may be applied at different points in the boot process or normal operation cycle. Should non-compliance to the policy be discovered, the enforcement function 328 may be activated. A discussion of enforcement policy and actions may be found in co-pending application U.S. patent application Ser. No.: 11/152,214. The enforcement function 328 may place the computer 300 into an alternate mode of operation when all attempts to restore the computer to compliance with the policy 322 fail. For example, in one embodiment, a sanction may be imposed by reallocating memory from use as system memory 130 and designating it use by the secure execution environment 302. Since memory in the secure execution environment may not addressable by outside programs including the operating system 134, the computer's operation may be restricted, even severely, by such memory allocation.

Because the policy and enforcement functions are maintained within the secure execution environment 302, some typical attacks on the system are difficult or impossible. For example, the policy may not be “spoofed” by replacing a policy memory section of external memory. Similarly, the policy and enforcement functions may not be “starved” by blocking execution cycles or their respective address ranges.

To revert the computer 300 to normal operation, a restoration code may need to be acquired from a licensing authority or service provider (not depicted) and entered into the computer 300. The restoration code may include the hardware ID 320, a stored value replenishment, and a “no-earlier-than” date used to verify the clock 326. The restoration code may typically be encrypted and signed for confirmation by the processing unit 302.

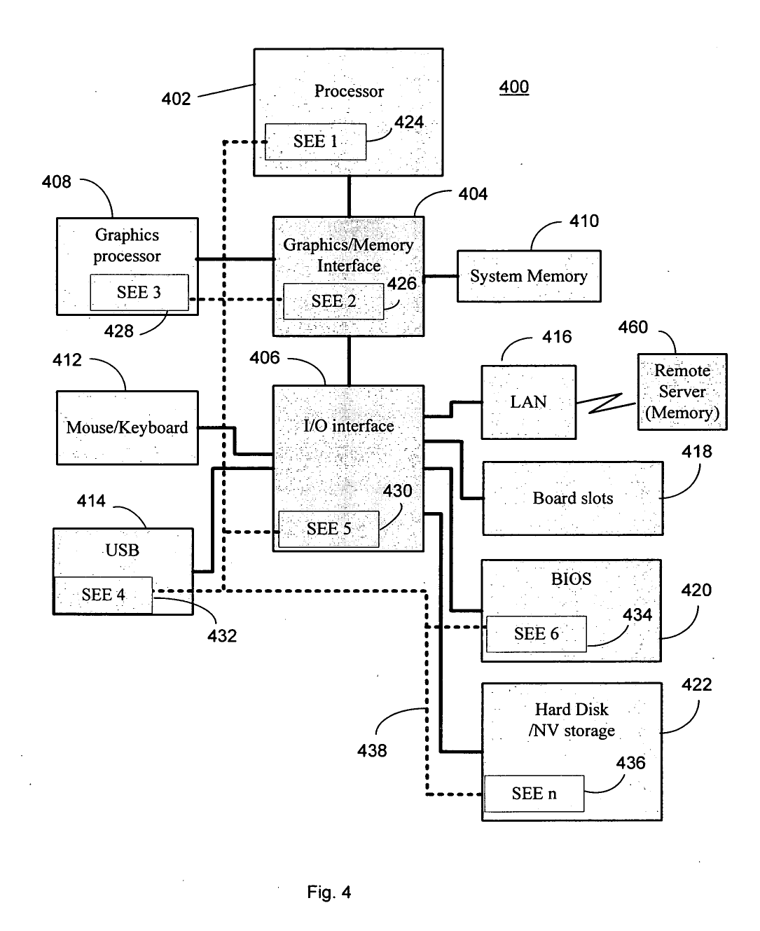

FIG. 4 illustrates an architecture of a computer 400 having multiple secure execution environments. In one embodiment, when more than one secure execution environment is present, a master secure execution environment may be used for managing system configuration while other secure execution environments may be used for redundant metering, metering confirmation, configuration confirmation, policy verification, and balance management. In another embodiment, each secure execution environment may be a peer with the others.

The computer 400, similar to the computer 300 of FIG. 3, may have a processor 402, a graphics and memory interface 404, and an I/O interface 406. The graphics and memory interface 404 may be coupled to a graphics processor 408 and a system memory 410. The I/O interface 406 may be coupled to one or more input devices 412 such as a mouse and keyboard. The I/O interface 406 may also be coupled to a universal serial bus (USB) 414, a local area network 416, peripheral board slots 418, a BIOS memory 420, and a hard disk 422 or other non-volatile storage, among others. In an exemplary embodiment, several of the components, including the processor 402, the graphics and memory interface 404, the I/O interface 406, and their respective functional components may each have a secure execution environment. For example, the processor 402, the graphics and memory interface 404, graphics processor 408, the I/O interface 406, the USB port 414, the BIOS memory 420, and the hard disk 422 may each have corresponding secure execution environments 424, 426, 428, 430, 432, 434, and 436. Each secure execution environment 424-436 may have access to different data or the ability to measure separate areas of performance for the purpose of determining compliance to the operating policy. In some cases, some secure execution environments may be weighted more than others when an overall evaluation of compliance to the operating policy is made. Correspondingly, each secure execution environment may impose sanctions in a different way. For example, the secure execution environment 432 in the USB interface 414 may be capable of imposing a sanction on all USB devices and may be able to have a ripple effect through to the I/O interface 406, but may allow continued operation of the computer. By contrast, the secure execution environment 424 in the processor 402 may be capable of dramatic sanctions up to ceasing all processor functions, thereby totally disabling the computer 400.

Each of the secure execution environments 424-436 may have all of the elements of the secure execution environment 302 of FIG. 3. The multiple secure execution environments may be employed for at least two general purposes. First, each of the secure execution environments 424-436 may monitor the general state of the computer 400 and participate in determining whether the computer 400 is being operated in compliance with an operating policy governing its use. Second, secure execution environments placed within the processor, interfaces, or functional components may be used to ensure that each component hosting a SEE is present and operational and has not been removed or otherwise disabled. In practice, the two purposes may go hand-in-hand.

In a first embodiment for using multiple secure execution environments for compliance with an operating policy, each secure execution environment 424-436 may maintain a copy of the operating policy 322, a stored value balance 340, if used. The policy management function 332 may specify the role of each of the secure execution environments. In one variation, one secure execution environment, for example, SEE 424, may be designated a Master SEE and may be responsible for overall policy management, stored value management, and may include the ability to veto a vote of noncompliance by any of the other secure execution environments. The Master SEE may also be able to disable a SEE from another component, or at least ignore inputs from a SEE that has been designated as disabled. For example, a SEE 436 associated with a particular model of hard disk drive 422 may be compromised and a message from a system owner or system underwriter may be sent to the Master SEE indicating the SEE 436 associated with the hard disk drive 422 is to be disabled and/or ignored. Each SEE, including the Master SEE may have a different operating policy for determining from its own perspective whether the computer is compliant. For example, a secure execution environment 432 in the USB port 414 may have access to different data and may “view the world” differently from secure execution environment 424 located in the processor 402. The Master SEE may receive periodic signals from each of the other secure execution environments and may determine compliance with the operating policy based on a “vote” determined by the information in the signal. Because each secure execution environment may vote according to its own operating policy, based on its view, votes may be taken in different ways: a majority vote may be required to impose sanctions, a single vote may be enough to impose a sanction, or some components, such as the graphics and memory interface SEE 426, may have more weight in a vote than another SEE.

In another variation for using multiple secure execution environments for compliance with an operating policy, each secure execution environment 424-436 may be considered a peer and may periodically collect status information from each of the other secure execution environments. Individual peer-to-peer connections may be maintained to facilitate such communication. In one embodiment, each secure execution environment may be cataloged in each of the other secure execution environments, such as at the time of assembly. The cataloging may include placing an identifier and a cryptographic key corresponding to each secure execution environment in the secure memory 318 of each of the secure execution environments present, in this example, the secure execution environments 424-436. The cryptographic keys may be symmetric keys known to all parties, or may use public key infrastructure keys, where a public key for each secure execution environment may be shared among the other secure execution environments. Cryptographic verification of messages is known and is not discussed in more detail.

A signal may be sent along a closed or predetermined route between each of the secure execution environments 424-436. At each stop on the route, a time, a compliance status or vote, and the identifier of the secure execution environment may be signed or encrypted, added to the signal, and forwarded to the next secure execution environment on the route. If an acknowledgement is not received, the signal may be forwarded to the next SEE in the route. If the signal does not complete the route and return within a predetermined amount of time or if the signal has out of date or missing elements corresponding to other secure execution environments, a sanction may be imposed. If the signal returns but also includes a vote for sanctioning from another secure execution environment, the recipient, based on its own rules, may also impose a sanction and forward the signal to the next secure execution environment on the route. The delays between secure execution environments may be monitored to determine that the signal is not being routed to a network destination for spoofing before being returned. In one embodiment, the network interface 416 may be temporarily shut off while the signal is being routed between secure execution environments to eliminate off-board routing.

To illustrate, the secure execution environments 424-436 may be logically organized in a ring. Periodically, in one embodiment a random interval, a signal may be launched from one of the SEEs. For the sake of example, SEE 424 launches a signal to SEE 426. The signal may include a data set including the time, status, and the identifier of SEE 424, signed by a derived key from a shared master key. For this example, the derived key may be based on the time or a nonce, which is then also included in the clear in the signal. When the signal arrives at SEE 426, the key may be derived, and the incoming signal verified for time and for the correct identifier. A clock mismatch may be indicative of a problem, although small cumulative changes may be ignored or corrected. If correct, SEE 426 may add its own signed time, status and identifier. The signal may proceed through all the secure execution environments in this fashion until it arrives again at SEE 424. SEE 424 may verify each appended data set for time, status and identifier. Lastly, it may check that its own original data set is present in the signal and that it has arrived back within a prescribed limit. Missing SEE data sets or status/votes of non-compliance may cause additional queries. A vote tally may be taken, with higher weighting given to designated secure execution environments when so programmed. If the vote of non-compliance meets a predetermined threshold, a sanction may be imposed. A signal may be propagated to other secure execution environments to activate general or specific sanctions, as the case warrants. Another benefit of using a nonce or random number in communication is to limit replay attacks that may be part of an overall attack on one or more individual secure execution environments.

Other embodiments may use a star configuration or other mechanism to variously launch signals and verify the results. In a master/slave environment, the master may be responsible for launching queries, although a slave may be programmed to trigger a query if a query from the master is overdue.

The communication between secure execution environments may be accomplished in a variety of ways. A secure execution environment and embedded within a component may use the components existing communication mechanisms to forward signals between secure execution environments. For example, SEE 436 may communicate to SEE 430 over the bus connecting the hard disk 422 to the I/O interface 406. This may be particularly effective for communication with secure execution environments in either in the graphics and memory interface 404 or the I/O interface 406. Processor and graphic/memory interface-based secure execution environments 424 426 may communicate via standard memory or I/O mapped interfaces supported on the front-side bus. Other options for piggybacking communication on existing buses, such as the peripheral component interconnect (PCI), may require modification of existing protocols to insert a software handler for routing inter-SEE packets. In another embodiment, a dedicated bus structure 438 may be used to couple each of the secure execution environments 424-436 to one another. A relatively low data rate may be acceptable for such communication. In one embodiment, an inter-integrated circuit (IIC or I²C) bus may be used. The IIC bus is a simple, two wire bus that is well known in the industry and would be suitable as a dedicated bus structure 438 between secure execution environments.

To accomplish the second general purpose, the same or similar signal routing discussed above may be used to bind components to each other, without necessarily being concerned about compliance to an operating policy. That is, to discourage computers from being stripped for parts, a component may be programmed to only operate correctly when in the verifiable presence of the other components cataloged with that computer. The query process above may be used, with the difference that the status may be dropped or ignored. When all components do not report, measures to locate the component may be taken, including messages to the user via a user interface. If the component cannot be located, sanctions may be imposed by one or more secure execution environments of the remaining components.

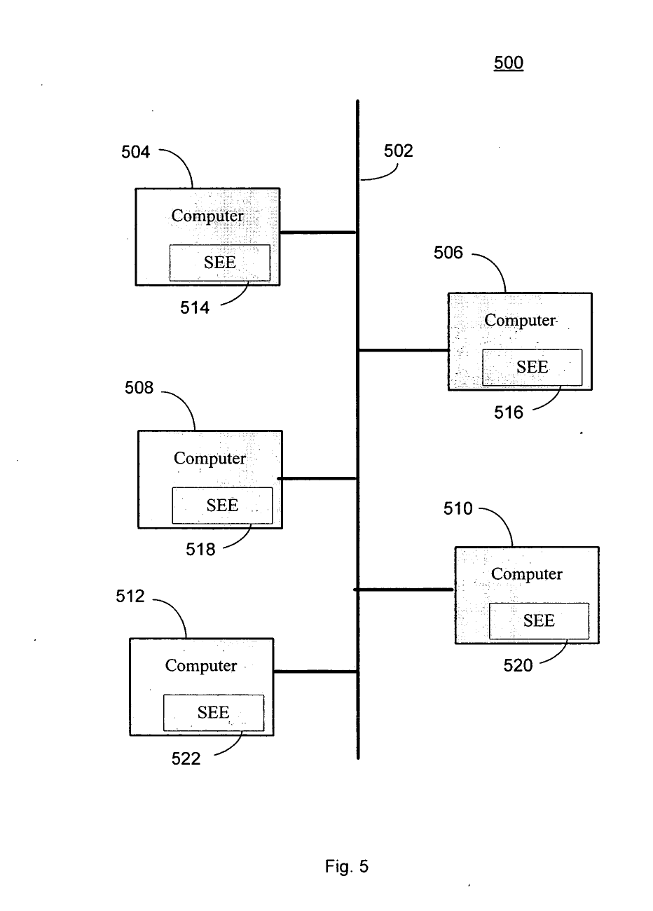

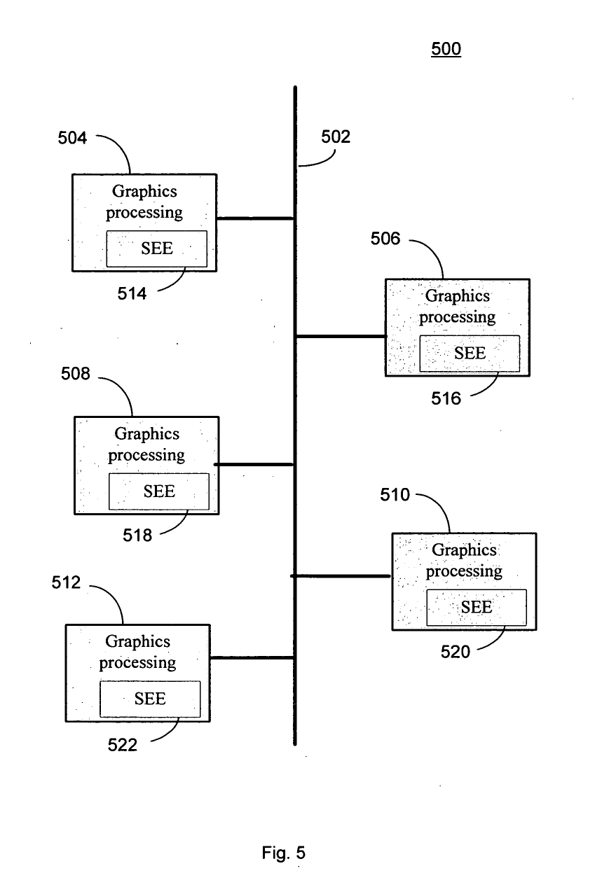

Similarly, as shown in FIG. 5, this same cataloging technique may be used to bind computers together into a system 500. For example, a number of computers 504, 506, 508, 510 and 512 may be designated for use by a particular entity on a given network 502. Each computer 504-512 designated for inclusion in the system may have a corresponding secure execution environment 514, 156, 518, 520, and 522 installed and each of the secure execution environments 514-522 catalogued in each of the other secure execution environments in the system. Periodically, each secure execution environment may determine, for example, using the signaling technique described above, that each of the other secure execution environments is still present, and by implication that its associated computer is also present. When the number of SEEs/computers reporting falls below a threshold, each secure execution environment may impose a sanction on its host computer.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer adapted for use including limited function operating modes comprising:
a processor;
a first secure execution environment communicatively coupled to the processor and operable to monitor and enforce compliance with an operating policy; and
a second secure execution environment communicatively coupled to the first secure execution environment and operable to monitor and enforce compliance with the operating policy and communicatively coupled to the first secure execution environment, wherein the second secure execution environment develops an assessment of compliance with the operating policy and sends a signal including the assessment to the first secure execution environment.

2. The computer of claim 1, wherein the signal further comprises a value corresponding to a metering value associated with one of a subscription status and a pay-per-use status.

3. The computer of claim 1, wherein the first secure execution environment maintains a stored value representing a usage availability.

4. The computer of claim 1, wherein the first secure execution environment receives the signal from the second secure execution environment and imposes a sanction on the computer when the signal indicates non-compliance with the policy.

5. The computer of claim 1, wherein the first secure execution environment receives the signal from the second secure execution environment and does not impose a sanction on the computer when the signal indicates non-compliance with the policy when the first secure execution environment determines compliance with the policy.

6. The computer of claim 1, wherein the first secure execution environment measures an interval between signals from the second secure execution environment and imposes a sanction on the computer when the interval exceeds a limit.

7. The computer of claim 1, wherein the first secure execution environment cryptographically verifies the signal from the second secure execution environment and imposes a sanction on the computer when the signal fails the verification.

8. The computer of claim 1, wherein the second secure execution environment imposes a sanction on the computer when the second secure execution environment determines non-compliance with the policy and a cryptographically verifiable veto message is not received from the first secure execution environment.

9. The computer of claim 1, further comprising an additional plurality of secure execution environments.

10. The computer of claim 9, wherein a majority vote of all secure execution environments determines when to sanction the computer.

11. The computer of claim 10, wherein the first secure execution environment receives a policy update to exclude one of the plurality of secure execution environments from the majority vote.

12. The computer of claim 9, further comprising a plurality of functional components wherein at least one of the first, second and additional plurality of secure execution environments are hosted in at least one of the plurality of functional components of the computer.

13. The computer of claim 12, wherein the first, second and additional plurality of secure execution environments are communicatively coupled using their respective host functional component's data connection.

14. The computer of claim 12, wherein the first, second and additional plurality of secure execution environments are communicatively coupled over a dedicated data connection.

15. A method of monitoring and enforcing compliance to an operating policy on a computer using a plurality of secure execution environments comprising:
establishing cryptographically secured communication among the plurality of secure execution environments;
monitoring compliance to a respective operating policy at each of the plurality of secure execution environments;
determining when the computer is not in compliance at least one of the respective operating policies; and
imposing a sanction on the computer when the computer is not in compliance with at least one of the respective operating policies.

16. The method of claim 15, wherein determining when the computer is not in compliance with the operating policy comprises receiving a vote from at least one of the plurality of secure execution environments and determining that the computer is not in compliance when a vote indicating non-compliance is received according to one of a single secure execution environment, a majority of secure execution environments, and a consensus of secure execution environments.

17. The method of claim 15, wherein determining when the computer is not in compliance with the operating policy comprises receiving a vote from each of the plurality of secure execution environments and determining that the computer is not in compliance when the vote from each of the plurality of secure execution environments is weighted and the total weighted vote exceeds a threshold.

18. The method of claim 15, further comprising designating one of the secure execution environments as a master and the remainder as slaves, wherein the master can override a determination of non-compliance made by one or more of the slaves.

19. A method of binding a set of computer components to a system comprising:
installing in each of the set of computer components a secure execution environment;
cataloging the secure execution environment of each of the computer components in each of the secure execution environments;
periodically determining that each of the cataloged secure execution environments of each of the respective computer components is present;
imposing a sanction when a secure execution environment determines that one or more of the other cataloged secure execution environments is not present.

20. The method of claim 19, wherein each of the computer components is in a separate, networked computer and the system is a collection of computers.
